(19) United States
(12) Patent Application Publication
(10) Pub. No.: US 2017/0120722 A1
(43) Pub. Date: May 4, 2017

(54) APPARATUS FOR CONTROLLING DIRECTION OF DISCHARGED AIR IN VEHICLE AIR CONDITIONING SYSTEM

(71) Applicant: Hyundai Motor Company, Seoul (KR)

(72) Inventors: Kwang Woon Cho, Yongin (KR); Keon Soo Jin, Ulsan (KR); Dae Ik Jung, Suwon (KR); Young Ju Lee, Suwon (KR)

(21) Appl. No.: 15/206,203

(22) Filed: Jul. 8, 2016

(30) Foreign Application Priority Data
Nov. 2, 2015 (KR) 10-2015-0153063

(51) Int. Cl. B60H 1/00; B60H 1/34

(52) U.S. Cl. CPC B60H 1/00685; B60H 1/3407; B60H 1/00842; B60H 2001/00721; B60H 2001/00707; B60H 2001/00192

(57) ABSTRACT

An apparatus for controlling a direction of discharged air in a vehicle air conditioning system can control a direction of air discharged to a vehicle interior from the vehicle air conditioning system. The apparatus includes a plurality of vent nozzles connected to an air discharge port for discharging air in the vehicle air conditioning system, so as to discharge air to different regions in a vehicle interior space, a plurality of discharge ducts connected between respective different sections of the air discharge port and the respective vent nozzles, and an opening and closing door configured to adjust an opening degree of the air discharge port, for selectively opening the different sections of the air discharge port.

### CROSS-REFERENCE TO RELATED APPLICATION

This application claims under 35 U.S.C. §119(a) the benefit of Korean Patent Application No. 10-2015-0153063 filed on Nov. 2, 2015, the entire contents of which are incorporated herein by reference.

### BACKGROUND

(a) Technical Field

The present invention relates to an apparatus for controlling a direction of discharged air in a vehicle air conditioning system, more particularly, to an apparatus for controlling the direction of air discharged to a vehicle interior from the vehicle air conditioning system.

(b) Description of the Related Art

A vehicle air conditioning system is one of the comfort systems provided in a vehicle, for example, in order to regulate the temperature of a vehicle interior to a desired level depending on surrounding environments, outdoor conditions for each season, etc., and to remove moisture or frost on a windshield glass.

In a vehicle, the temperature and/or humidity of air are regulated by an air conditioning system, and the air is discharged to a vehicle interior through a duct installed between an air discharge port of the air conditioning system and the vehicle interior, where the direction of the air is controllable by adjusting the angles of blades installed in the outlet of the duct.

The above information disclosed in this Background section is only for enhancement of understanding of the background of the invention and therefore it may contain information that does not form the prior art that is already known in this country to a person of ordinary skill in the art.

### SUMMARY

In one aspect, the present invention provides an apparatus for controlling a direction of air discharged to a vehicle interior from a vehicle air conditioning system after various conditions, such as temperature and humidity, of the air are regulated by the vehicle air conditioning system.

In a preferred embodiment, an apparatus for controlling a direction of discharged air in a vehicle air conditioning system includes a plurality of vent nozzles connected to an air discharge port for discharging air in the vehicle air conditioning system, so as to discharge air to different regions in a vehicle interior space, a plurality of discharge ducts connected between respective different sections of the air discharge port and the respective vent nozzles, and an opening and closing door configured to adjust an opening degree of the air discharge port, for selectively opening the different sections of the air discharge port.

The vent nozzles may include upper and lower center vent nozzles arranged at a center portion of an instrument panel, formed between the vehicle air conditioning system and the vehicle interior space, while being vertically spaced apart from each other, upper and lower right vent nozzles arranged at a right portion of the instrument panel while being vertically spaced apart from each other, and upper and lower left vent nozzles arranged at a left portion of the instrument panel while being vertically spaced apart from each other.

The discharge ducts may include an upper right discharge duct connected between the air discharge port and a right end of the upper right vent nozzle, a lower right discharge duct connected between the air discharge port and a right end of the lower right vent nozzle, an upper left discharge duct connected between the air discharge port and a left end of the upper left vent nozzle, and a lower left discharge duct connected between the air discharge port and a left end of the lower left vent nozzle. Furthermore, the discharge ducts may include a first upper center discharge duct connected between the air discharge port, a right end of the upper center vent nozzle, and a left end of the upper right vent nozzle, a second upper center discharge duct connected between the air discharge port, a left end of the upper center vent nozzle, and a right end of the upper left vent nozzle, a first lower center discharge duct connected between the air discharge port, a right end of the lower center vent nozzle, and a left end of the lower right vent nozzle, and a second lower center discharge duct connected between the air discharge port, a left end of the lower center vent nozzle, and a right end of the lower left vent nozzle.

The opening and closing door may include an outer door rotatably installed in the vehicle air conditioning system, and an inner door rotatably installed on the same axis as the outer door, and the outer door may have a plurality of outer opening portions circumferentially formed on an outer peripheral surface thereof, and the inner door may have a plurality of inner opening portions circumferentially formed on an outer peripheral surface thereof, so that the opening degree of the air discharge port is determined by one of the outer opening portions and one of the inner opening portions depending on directions and angles of rotation of the outer and inner doors.

The outer opening portions may include a right outer opening portion, a first full outer opening portion, a left outer opening portion, and a second full outer opening portion sequentially formed in the circumferential direction of the outer door, the right outer opening portion may be formed at one of the left and right sides with respect to an axial direction of the outer door, the left outer opening portion may be formed at the other of the left and right sides with respect to the axial direction of the outer door, and the first and second full outer opening portions may be formed at both of the left and right sides so as to extend in the axial direction of the outer door.

The first and second full outer opening portions may face each other on a circumference of the outer door, and the right and left outer opening portions may face each other in a diagonal direction on the circumference of the outer door.

The first and second full outer opening portions may be formed so as to open the overall air discharge port, the right outer opening portion may be formed so as to open a right section of the air discharge port, and the left outer opening portion may be formed so as to open a left section of the air discharge port.

The inner opening portions may include a lower inner opening portion, a first full inner opening portion, an upper inner opening portion, and a second full inner opening portion sequentially formed in the circumferential direction of the inner door, the lower inner opening portion may be formed at one of upper and lower sides with respect to the circumferential direction of the inner door, the upper inner opening portion may be formed at the other of the upper and lower sides with respect to the circumferential direction of the inner door, and the first and second full inner opening portions may be formed at both left and right sides so as to extend in an axial direction of the inner door.

The first and second full inner opening portions may face each other on a circumference of the inner door, and the upper and lower inner opening portions may be disposed so as to be closer to the first full inner opening portion than to the second full inner opening portion.

The first and second full inner opening portions may be formed so as to open the overall air discharge port, the lower inner opening portion may be formed so as to open a lower section of the air discharge port, and the upper inner opening portion may be formed so as to open an upper section of the air discharge port.

Each of the vent nozzles may have a hollow pipe shape, and be provided with a discharge gap, formed in such a manner that one side of an outer peripheral surface of the vent nozzle is longitudinally opened, for discharging air.

An outer actuator for rotating the outer door and an inner actuator for rotating the inner door may be installed outside the vehicle air conditioning system, and the outer and inner actuators may be disposed on axial lines of the outer and inner doors so as to face each other.

Other aspects and preferred embodiments of the invention are discussed infra.

As is apparent from the above description, in accordance with an apparatus for controlling a direction of discharged air in a vehicle air conditioning system according to the present invention, the direction of air can be controlled by regulating the volume of air, which is discharged from respective vent nozzles disposed at different positions on an instrument panel, using an opening and closing door installed in the vehicle air conditioning system.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic cross-sectional view of an apparatus for controlling a direction of discharged air in a vehicle air conditioning system according to an embodiment of the present invention;

FIG. 2 is a schematic top view of the apparatus depicted in FIG. 1;

FIG. 3 is a perspective view illustrating an opening and closing unit for opening and closing an air discharge port of the vehicle air conditioning system in the apparatus for controlling the direction of discharged air in the vehicle air conditioning system according to the embodiment of the present invention;

FIG. 4 is a cross-sectional view of the opening and closing unit depicted in FIG. 3;

FIG. 5 is a development view of inner and outer doors constituting an opening and closing door in the opening and closing unit according to the embodiment of the present invention;

FIG. 6 is a schematic view illustrating a cross-sectional structure of one vent nozzle according to the embodiment of the present invention;

FIG. 7 is a perspective view illustrating a full open mode of the opening and closing door according to the embodiment of the present invention;

FIG. 8 is a perspective view illustrating a right open mode of the opening and closing door according to the embodiment of the present invention;

FIG. 9 is a perspective view illustrating a left open mode of the opening and closing door according to the embodiment of the present invention;

FIG. 10 is a perspective view illustrating an upper open mode of the opening and closing door according to the embodiment of the present invention;

FIG. 11 is a schematic cross-sectional view of the upper open mode of the opening and closing door depicted in FIG. 10;

FIG. 12 is a perspective view illustrating a lower open mode of the opening and closing door according to the embodiment of the present invention;

FIG. 13 is a schematic cross-sectional view of the lower open mode of the opening and closing door depicted in FIG. 12;

FIG. 14 is a perspective view illustrating a right upper open mode of the opening and closing door according to the embodiment of the present invention;

FIG. 15 is a perspective view illustrating a left upper open mode of the opening and closing door according to the embodiment of the present invention;

FIG. 16 is a perspective view illustrating a right lower open mode of the opening and closing door according to the embodiment of the present invention; and

FIG. 17 is a perspective view illustrating a left lower open mode of the opening and closing door according to the embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention relates to an apparatus for controlling a direction of discharged air in a vehicle air conditioning system, which is capable of realizing an air direction control function by regulating the volume of air, which is discharged from respective vent nozzles disposed at different positions on an instrument panel provided in front of a vehicle interior space. Such an air direction control function can be controlled by discharging air, the temperature and/or humidity of which are/is regulated by an air conditioner, a heater, etc. included in the air conditioning system, to different regions in the vehicle interior space when the air is discharged through an air discharge port included in a casing of the air conditioning system.

Hereinafter, the exemplary embodiment of the present invention will be described in detail with reference to the accompanying drawings.

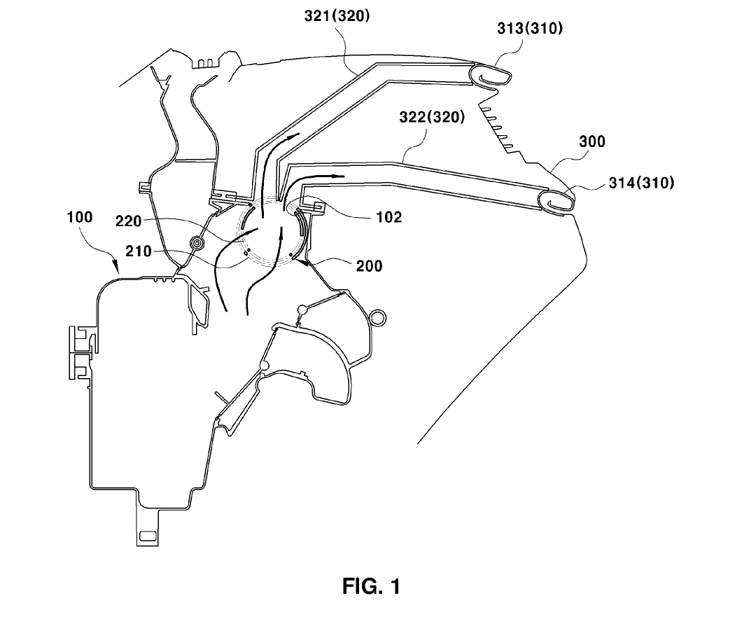

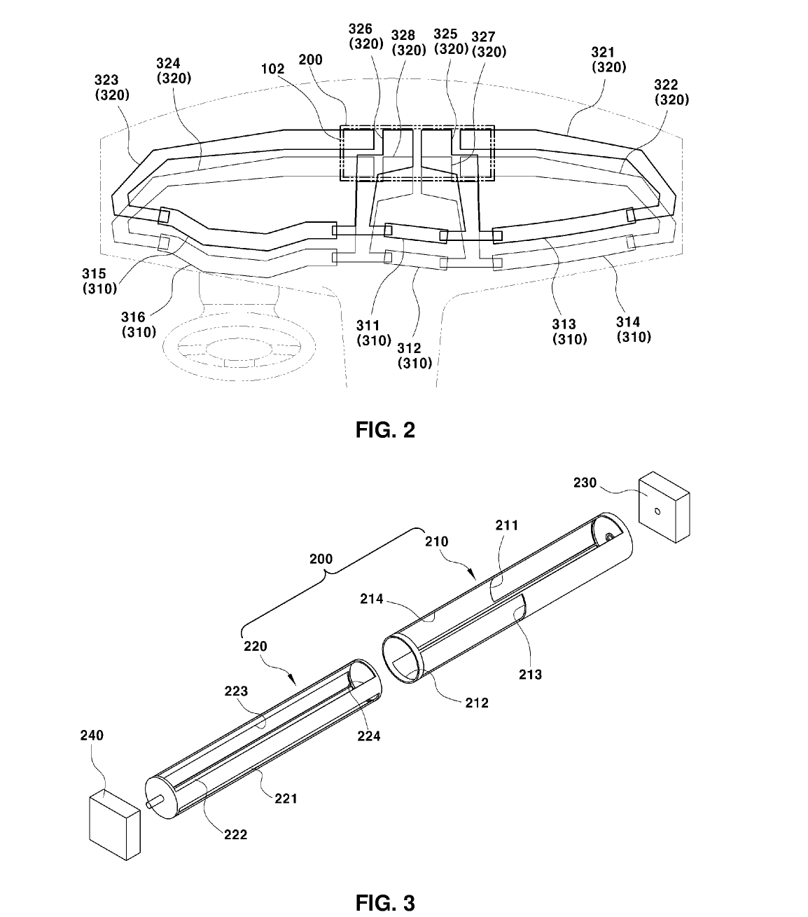

As illustrated in FIGS. 1 and 2, an air conditioning system (i.e., a vehicle air conditioning system), which is designated by reference numeral 100, includes an opening and closing door 200 which adjusts the opening degree of an air discharge port 102 provided at one side thereof.

The air conditioning system 100 has the air discharge port 102 for discharging air introduced thereinto while having a regulated temperature or the like. Air may be discharged to different regions in a vehicle interior space by adjusting the opening degree of the air discharge port 102 so as to open the overall air discharge port 102 or selectively open the partitioned upper, lower, left, and right sections of the air discharge port 102, using the opening and closing door 200.

The air conditioning system 100 preferably is installed in a separate space divided from the vehicle interior space by an instrument panel 300 disposed in front of the vehicle interior space. A plurality of vent nozzles 310 and a plurality of discharge ducts 320 are installed between the instrument panel 300 and the air discharge port 102 of the air conditioning system 100.

The vent nozzles 310 are arranged on the instrument panel 300 formed between the air conditioning system 100 and the vehicle interior space. The vent nozzles 310 comprise upper and lower center vent nozzles 311 and 312 which are installed at the center portion of the instrument panel 300 while being vertically spaced apart from each other; upper and lower right vent nozzles 313 and 314 which are installed at the right portion of the instrument panel 300 while being vertically spaced apart from each other; and upper and lower left vent nozzles 315 and 316 which are installed at the left portion of the instrument panel 300 while being vertically spaced apart from each other.

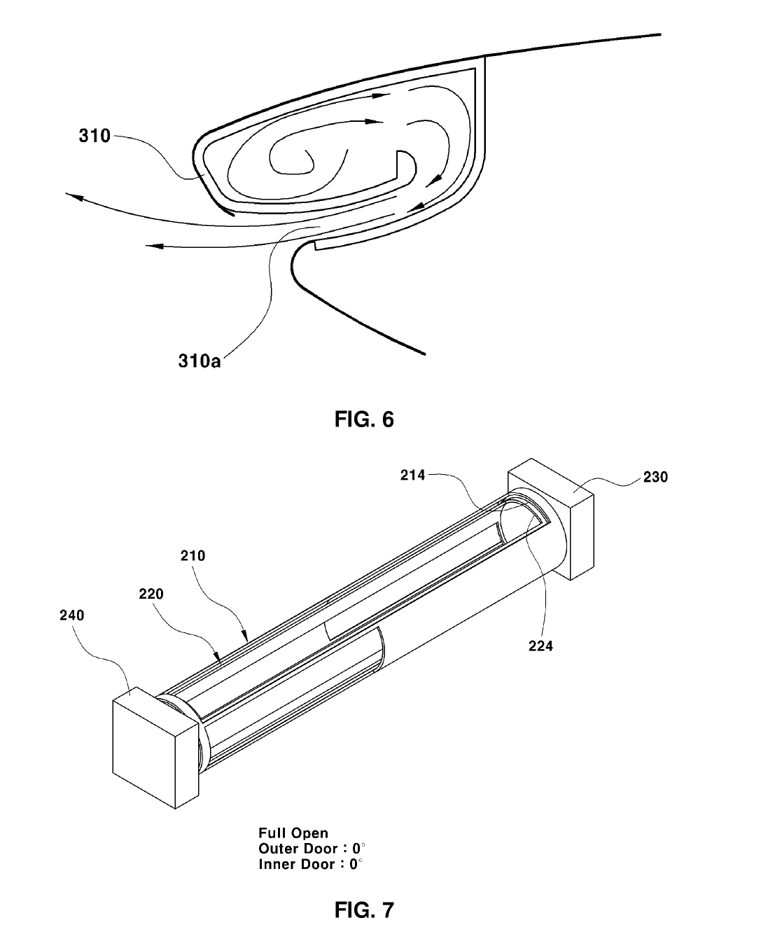

Each of the vent nozzles 310 is provided with a discharge gap 310a (see FIG. 6) through which air is discharged to the vehicle interior space. The respective surfaces including the discharge gaps 310a of the vent nozzles 310 are arranged at different positions on the instrument panel 300 such that air is discharged to the different regions in the vehicle interior space.

The discharge ducts 320 are connected between the respective sections of the air discharge port 102 and the respective vent nozzles 310. The discharge ducts 320 comprise an upper right discharge duct 321 which is connected between the air discharge port 102 and the right end of the upper right vent nozzle 313; a lower right discharge duct 322 which is connected between the air discharge port 102 and the right end of the lower right vent nozzle 314; an upper left discharge duct 323 which is connected between the air discharge port 102 and the left end of the upper left vent nozzle 315; a lower left discharge duct 324 which is connected between the air discharge port 102 and the left end of the lower left vent nozzle 316; a first upper center discharge duct 325 which is connected between the air discharge port 102, the right end of the upper center vent nozzle 311, and the left end of the upper right vent nozzle 313; a second upper center discharge duct 326 which is connected between the air discharge port 102, the left end of the upper center vent nozzle 311, and the right end of the upper left vent nozzle 315; a first lower center discharge duct 327 which is connected between the air discharge port 102, the right end of the lower center vent nozzle 312, and the left end of the lower right vent nozzle 314; and a second lower center discharge duct 328 which is connected between the air discharge port 102, the left end of the lower center vent nozzle 312, and the right end of the lower left vent nozzle 316.

In this case, the respective inlets of the discharge ducts 320 are connected adjacent to the different sections of the air discharge port 102, i.e., the upper, lower, left, and right sections thereof (or the front, rear, left, and right sections thereof) such that air may flow therethrough. Thus, the air discharged from the air conditioning system 100 is introduced into the selected one of the discharge ducts by adjusting the opening degree of the air discharge port 102.

The opening and closing door 200 for selectively opening the different sections of the air discharge port 102 is installed in the air conditioning system 100 so as to be adjacent to the air discharge port 102.

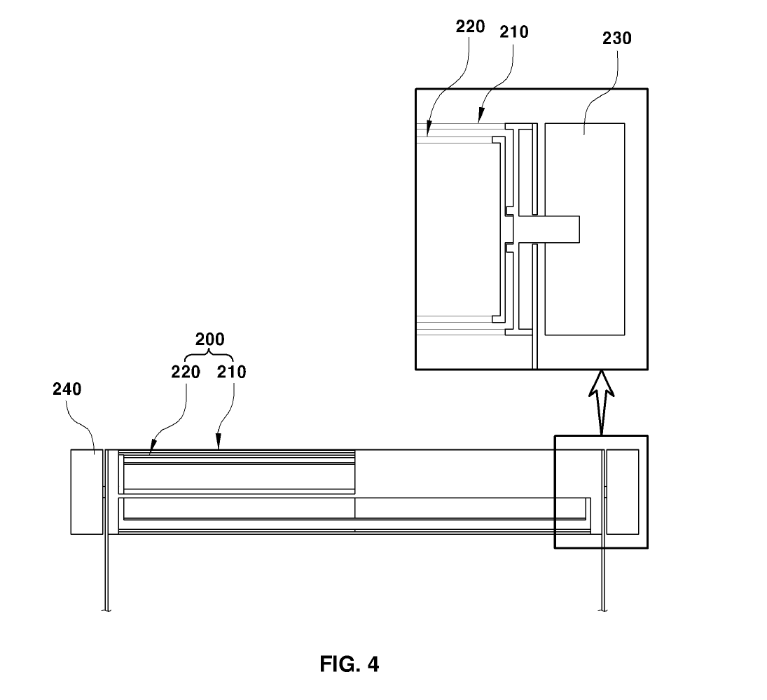

As illustrated in FIGS. 3 and 4, the opening and closing door 200 includes an outer door 210 which is rotatably installed in the air conditioning system 100, and an inner door 220 which is rotatably installed on the same axis as the outer door 210.

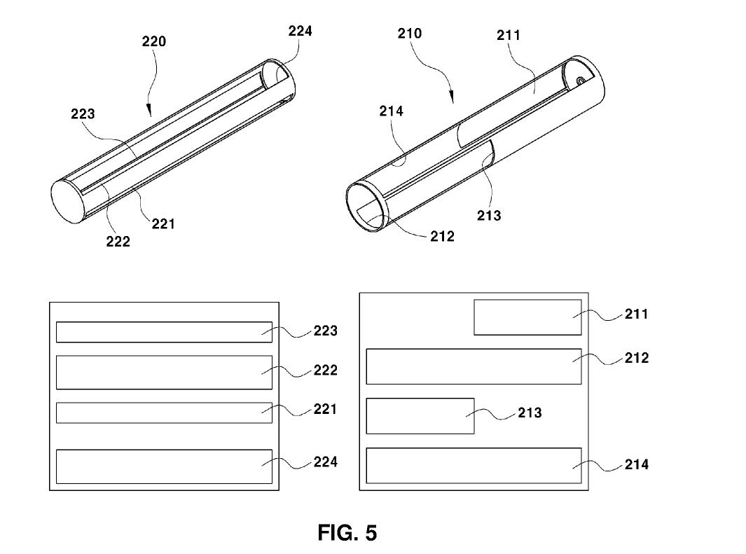

As illustrated in FIGS. 3 to 5, the outer door 210 has a plurality of outer opening portions 211, 212, 213, and 214 which are circumferentially formed on the outer peripheral surface thereof, and the inner door 220 has a plurality of inner opening portions 221, 222, 223, and 224 which are circumferentially formed on the outer peripheral surface thereof.

The outer opening portions 211, 212, 213, and 214 comprise a right outer opening portion 211, a first full outer opening portion 212, a left outer opening portion 213, and a second full outer opening portion 214, which are sequentially formed in the circumferential direction of the outer door 210. The right outer opening portion 211 is formed at one of the left and right sides with respect to the axial direction of the outer door 210; the left outer opening portion 213 is formed at the other of the left and right sides with respect to the axial direction of the outer door 210; and the first and second full outer opening portions 212 and 214 are formed at both of the left and right sides so as to extend in the axial direction of the outer door 210.

In this case, the first and second full outer opening portions 212 and 214 face each other on the circumference of the outer door 210, and the right and left outer opening portions 211 and 213 face each other in a diagonal direction on the circumference of the outer door 210.

The first and second full outer opening portions 212 and 214 are formed so as to open the overall air discharge port 102; the right outer opening portion 211 is formed so as to open the right section of the air discharge port 102; and the left outer opening portion 213 is formed so as to open the left section of the air discharge port 102.

In addition, the adjacent outer opening portions on the circumference of the outer door 210 are formed at a certain interval.

The inner opening portions 221, 222, 223, and 224 comprise a lower inner opening portion 221, a first full inner opening portion 222, an upper inner opening portion 223, and a second full inner opening portion 224, which are sequentially formed in the circumferential direction of the inner door 220. The lower inner opening portion 221 is formed at one of the upper and lower sides (or at one of the front and rear sides) with respect to the circumferential direction of the inner door 220; the upper inner opening portion 223 is formed at the other of the upper and lower sides (or at the other of the front and rear sides) with respect to the circumferential direction of the inner door 220; and the first and second full inner opening portions 222 and 224 are formed at both of the left and right sides so as to extend in the axial direction of the inner door 220.

In this case, the first and second full inner opening portions 222 and 224 face each other on the circumference of the inner door 220, and the upper and lower inner opening portions 223 and 221 are formed at both sides of the first full inner opening portion 222 so as to be closer to the first full inner opening portion 222 than to the second full inner opening portion 224.

The first and second full inner opening portions 222 and 224 are formed so as to open the overall air discharge port 102; the upper inner opening portion 223 is formed so as to open the upper section of the air discharge port 102; and the lower inner opening portion 221 is formed so as to open the lower section of the air discharge port 102.

The opening degree of the air discharge port 102 is determined by one of the outer opening portions 211, 212, 213, and 214 and one of the inner opening portions 221, 222, 223, and 224 according to the directions and angles of rotation of the outer and inner doors 210 and 220 of the opening and closing door 200, thereby enabling air to be discharged to the selected one of the discharge ducts 320.

In addition, since the opening and closing door 200 is installed in the air conditioning system 100 in the state in which it blocks the air discharge port 102, the air conditioned by the air conditioning system 100 is introduced into the opening and closing door 200 through the remaining outer and inner opening portions, except the outer and inner opening portions used to determine the opening degree of the air discharge port 102.

The opening and closing door 200 is configured as an opening and closing unit, for opening and closing the air discharge port 102, which includes an outer actuator 230 for rotating the outer door 210 and an inner actuator 240 for rotating the inner door 220.

Referring to FIG. 4, the outer and inner actuators 230 and 240 are fixedly installed outside the air conditioning system 100, and are installed on the axial lines of the outer and inner doors 210 and 220 so as to face each other.

For example, the outer and inner actuators 230 and 240 may be comprised of an electric motor and a reducer.

Meanwhile, each of the vent nozzles 310 has a hollow pipe shape. As illustrated in FIG. 6, the vent nozzle 310 has the discharge gap 310a formed in such a manner that one side of the outer peripheral surface of the vent nozzle 310 is longitudinally opened, for discharging air to the vehicle interior space.

The discharge gap 310a extends in the longitudinal direction of the vent nozzle 310, and the tip of the discharge gap 310a is formed so as to be located on the instrument panel 300, such that air may be discharged to the vehicle interior space through the discharge gap 310a.

In addition, a vertex which rotates and flows is formed in each vent nozzle 310, the vertex being formed by collision of air introduced from the discharge ducts 320 connected to both ends of the vent nozzle 310. In this case, the vent nozzle 310 has a circumferential winding structure, in order for air discharged to the vehicle interior space through the discharge gap 310a to be discharged while being oriented in the rotation direction of the vertex.

In addition, the discharge gap 310a is located at the lower end of the vent nozzle 310 in order to improve the visual exposure of the discharge gap 310a.

Hereinafter, the operation modes of the opening and closing door will be described with reference to FIGS. 7 to 17.

As illustrated in FIGS. 7 to 17, the operation modes of the opening and closing door 200 may be classified into a full open mode, an upper open mode, a lower open mode, a right open mode, a left open mode, a right upper open mode, a left upper open mode, a right lower open mode, and a left lower open mode.

When the initial mode of the opening and closing door 200 is assumed to be a full open mode, each operation mode may be described as follows.

First, referring to FIG. 7, when the opening and closing door 200 is operated in the full open mode, the outer and inner doors 210 and 220 are rotated by an angle of 0° so that the overall air discharge port 102 is opened, regardless of the upper, lower, left, and right (or front, rear, left, and right) sections thereof, by both of the second full outer opening portion 214 (or the first full outer opening portion) and the second full inner opening portion 224 (or the first full inner opening portion). Consequently, air is discharged from the air conditioning system 100 to the vehicle interior space through the vent nozzles 310 connected to the air discharge port 102.

In this case, the second full outer opening portion 214 of the outer door 210 is located on the air discharge port 102, and the second full inner opening portion 224 of the inner door 220 is located on the air discharge port 102 (see FIG. 1). Accordingly, air may be introduced into the discharge ducts 320 connected to the air discharge port 102.

Each of the second full outer opening portion 214 of the outer door 210 and the second full inner opening portion 224 of the inner door 220 is formed so as to open the overall air discharge port 102, regardless of the upper, lower, left, and right sections thereof.

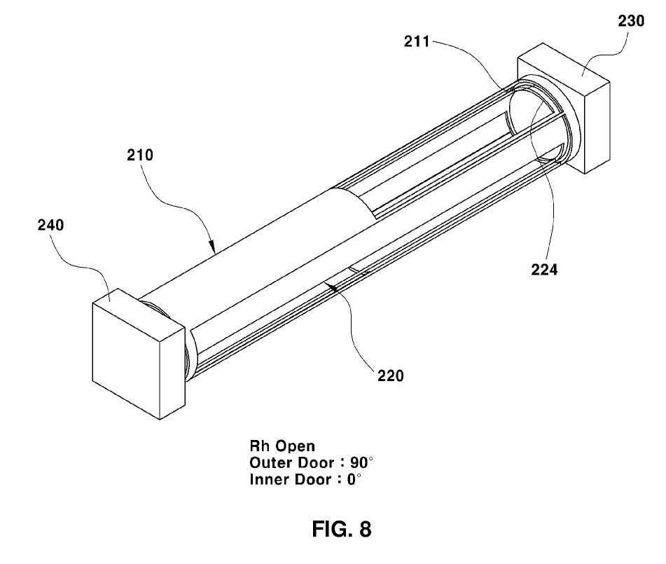

Next, referring to FIG. 8, when the opening and closing door 200 is operated in the right open mode, the inner door 220 is rotated by an angle of 0° so that the second full inner opening portion 224 opens the overall air discharge port 102, regardless of the sections thereof, and the outer door 210 is rotated clockwise by an angle of 90° so that the right outer opening portion 211 opens only the right section of the upper, lower, left, and right sections of the air discharge port 102. Consequently, air may be introduced into only the partial discharge ducts 321, 322, 325, and 327 (see FIG. 2) connected to the right section of the air discharge port 102 such that air may flow therethrough.

The right section of the air discharge port 102 is connected to only the inlets of the discharge ducts, connected to the upper and lower right vent nozzles 313 and 314, from among the discharge ducts 320. Accordingly, most of air discharged from the air conditioning system 100 is discharged to the vehicle interior space through the upper and lower right vent nozzles 313 and 314.

In this case, the partial discharge ducts, i.e. the first upper and lower center discharge ducts 325 and 327, of the discharge ducts connected to the upper and lower right vent nozzles 313 and 314 are connected to the upper and lower center vent nozzles 311 and 312 such that air may flow therethrough. Accordingly, a small amount of air is discharged to the central region in the vehicle interior space through the upper and lower center vent nozzles 311 and 312.

In other words, when the opening and closing door 200 is operated in the full open mode, the outer door 210 is rotated clockwise by an angle of 90° so that the right outer opening portion 211 opens only the right section of the air discharge port 102. Consequently, most of air discharged from the air conditioning system 100 is discharged to the right region in the vehicle interior space.

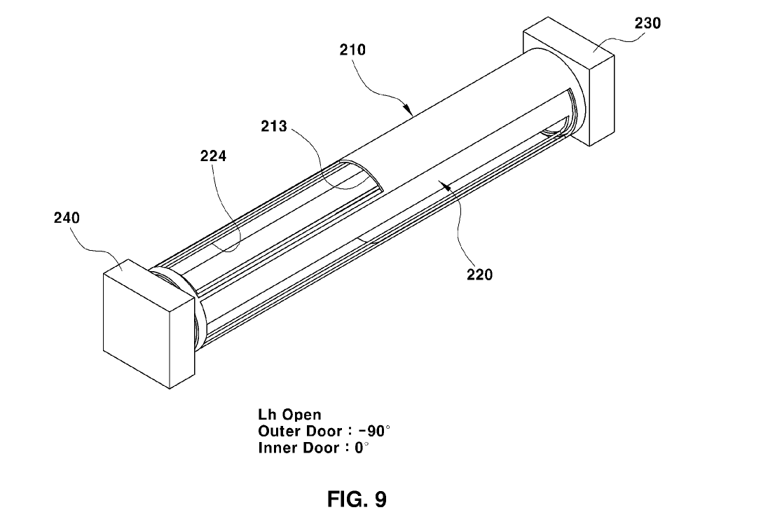

Next, referring to FIG. 9, when the full open mode of the opening and closing door 200 is converted into a left open mode so that the opening and closing door 200 is operated in the left open mode, the inner door 220 is rotated by an angle of 0° so that the second full inner opening portion 224 opens the overall air discharge port 102, regardless of the sections thereof, and the outer door 210 is rotated counterclockwise by an angle of 90° so that the left outer opening portion 213 opens only the left section of the upper, lower, left, and right sections of the air discharge port 102. Consequently, air may be introduced into only the partial discharge ducts 323, 324, 326, and 328 (see FIG. 2) connected to the left section of the air discharge port 102 such that air may flow therethrough.

The left section of the air discharge port 102 is connected to only the discharge ducts, connected to the upper and lower left vent nozzles 315 and 316, from among the discharge ducts. Accordingly, most of air discharged from the air conditioning system 100 is discharged to the left region in the vehicle interior space through the upper and lower left vent nozzles 315 and 316.

In this case, the partial discharge ducts, i.e. the second upper and lower center discharge ducts 326 and 328, of the discharge ducts connected to the upper and lower left vent nozzles 315 and 316 are connected to the upper and lower center vent nozzles 311 and 312 such that air may flow therethrough. Accordingly, a small amount of air is discharged to the central region in the vehicle interior space through the upper and lower center vent nozzles 311 and 312.

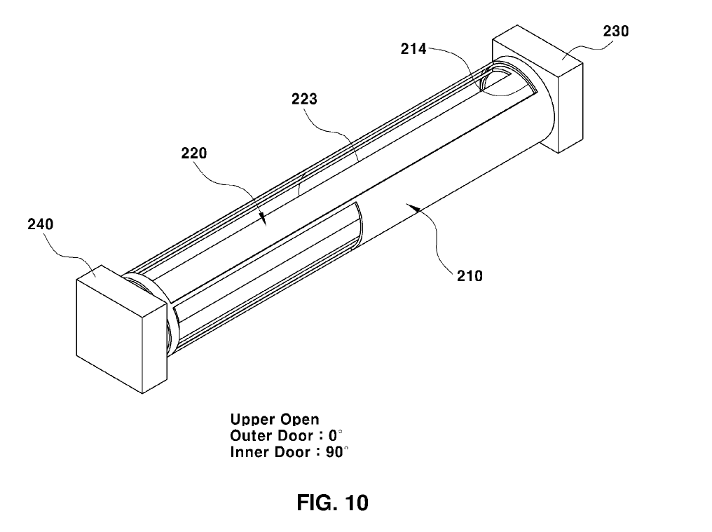

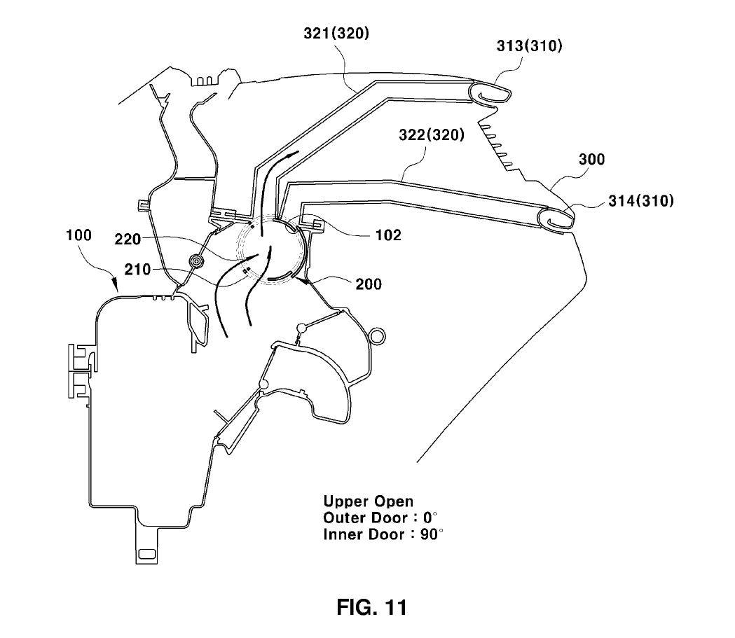

Next, referring to FIG. 10, when the full open mode of the opening and closing door 200 is converted into an upper open mode so that the opening and closing door 200 is operated in the upper open mode, the outer door 210 is rotated by an angle of 0° so that the second full outer opening portion 214 opens the overall air discharge port 102, regardless of the sections thereof, and the inner door 220 is rotated clockwise by an angle of 90° so that the upper inner opening portion 223 opens only the upper section of the upper, lower, left, and right sections of the air discharge port 102 (see FIG. 11). Consequently, air may be introduced into only the partial discharge ducts 321, 323, 325, and 326 (see FIG. 2) connected to the upper section of the air discharge port 102 such that air may flow therethrough.

The upper section of the air discharge port 102 is connected to only the discharge ducts, connected to the upper left and right vent nozzles 315 and 313 and the upper center vent nozzle 311, from among the discharge ducts. Accordingly, all of air discharged from the air conditioning system 100 is discharged to the upper region in the vehicle interior space through the upper left and right vent nozzles 315 and 313 and the upper center vent nozzle 311.

In this case, the discharge ducts connected to the upper left and right vent nozzles 315 and 313 and the upper center vent nozzle 311 are the upper left and right discharge ducts 323 and 321, the second upper center discharge duct 326, and the first upper center discharge duct 325.

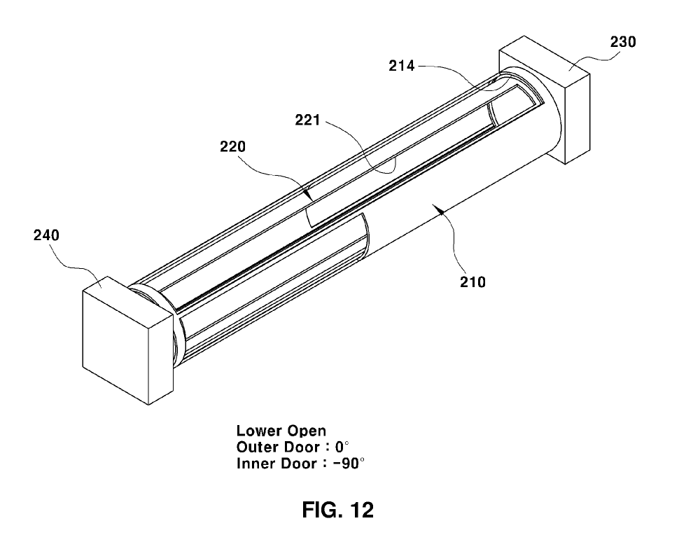

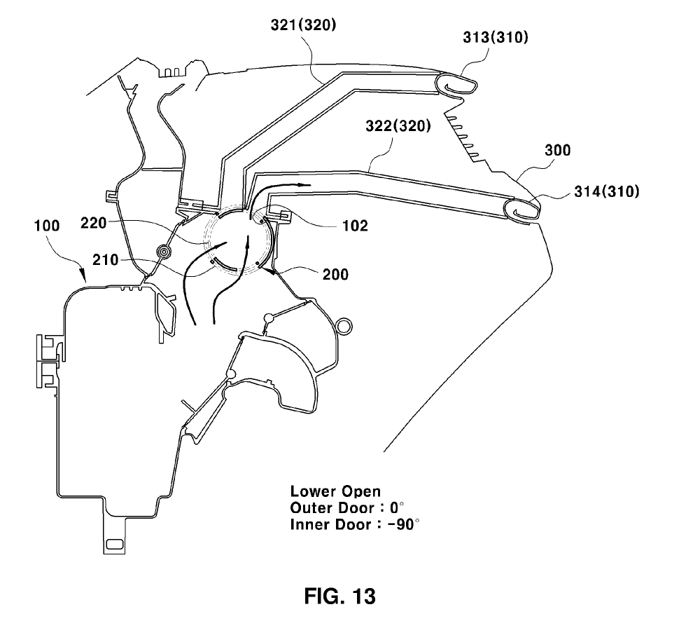

Next, referring to FIG. 12, when the full open mode of the opening and closing door 200 is converted into a lower open mode so that the opening and closing door 200 is operated in the lower open mode, the outer door 210 is rotated by an angle of 0° so that the second full outer opening portion 214 opens the overall air discharge port 102, regardless of the sections thereof, and the inner door 220 is rotated counterclockwise by an angle of 90° so that the lower inner opening portion 221 opens only the lower section of the upper, lower, left, and right sections of the air discharge port 102 (see FIG. 13). Consequently, air may be introduced into only the partial discharge ducts 322, 324, 327, and 328 (see FIG. 2) connected to the lower section of the air discharge port 102 such that air may flow therethrough.

The lower section of the air discharge port 102 is connected to only the discharge ducts, connected to the lower left and right vent nozzles 316 and 314 and the lower center vent nozzle 312, from among the discharge ducts. Accordingly, all of air discharged from the air conditioning system 100 is discharged to the lower region in the vehicle interior space through the lower left and right vent nozzles 316 and 314 and the lower center vent nozzle 312.

In this case, the discharge ducts connected to the lower left and right vent nozzles 316 and 314 and the lower center vent nozzle 312 are the lower left and right discharge ducts 324 and 322, the second lower center discharge duct 328, and the first lower center discharge duct 327.

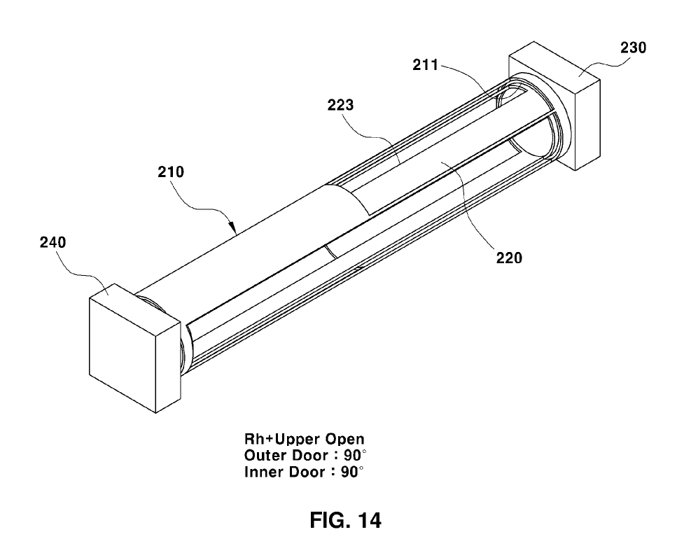

Next, referring to FIG. 14, when the full open mode of the opening and closing door 200 is converted into a right upper open mode so that the opening and closing door 200 is operated in the right upper open mode, the outer door 210 is rotated clockwise by an angle of 90° so that the right outer opening portion 211 opens only the right section of the upper, lower, left, and right sections of the air discharge port 102, and the inner door 220 is rotated clockwise by an angle of 90° so that the upper inner opening portion 223 opens only the upper section of the upper, lower, left, and right sections of the air discharge port 102. Consequently, the sections, which are opened (simultaneously) by both of the right outer opening portion 211 and the upper inner opening portion 223, from among the sections of the air discharge port 102, are opened such that air may be discharged to only the above sections.

That is, only the right and upper sections of the upper, lower, left, and right sections of the air discharge port 102 are opened, and most of air discharged from the air conditioning system 100 through the upper right discharge duct 321 and the first upper center discharge duct 325 connected to the right and upper sections such that air may flow therethrough is discharged to the right region in the vehicle interior space through the upper right vent nozzle 313.

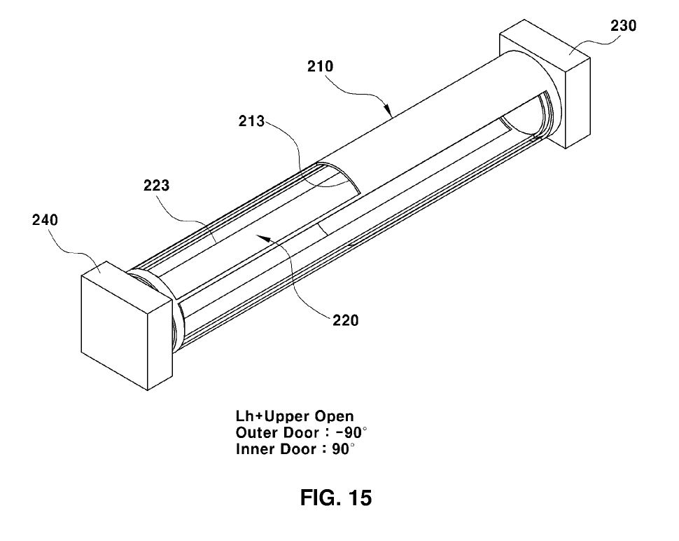

Next, referring to FIG. 15, when the full open mode of the opening and closing door 200 is converted into a left upper open mode so that the opening and closing door 200 is operated in the left upper open mode, the outer door 210 is rotated counterclockwise by an angle of 90° so that the left outer opening portion 213 opens only the left section of the upper, lower, left, and right sections of the air discharge port 102, and the inner door 220 is rotated clockwise by an angle of 90° so that the upper inner opening portion 223 opens only the upper section of the upper, lower, left, and right sections of the air discharge port 102. Consequently, the sections, which are opened simultaneously by the left outer opening portion 213 and the upper inner opening portion 223, from among the sections of the air discharge port 102, are opened such that air may be discharged to only the above sections.

That is, only the left and upper sections of the upper, lower, left, and right sections of the air discharge port 102 are opened, and most of air discharged from the air conditioning system 100 through the upper left discharge duct 323 and the second upper center discharge duct 326 connected to the left and upper sections such that air may flow therethrough is discharged to the left and upper regions in the vehicle interior space through the upper left vent nozzle 315.

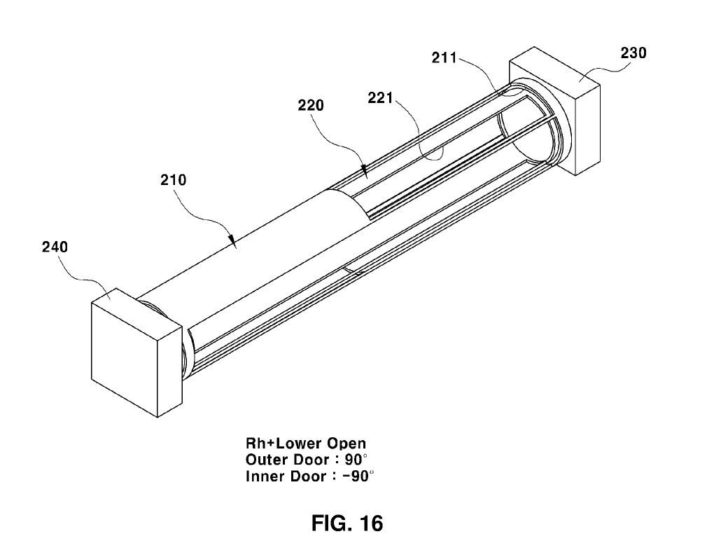

Next, referring to FIG. 16, when the full open mode of the opening and closing door 200 is converted into a right lower open mode so that the opening and closing door 200 is operated in the right lower open mode, the outer door 210 is rotated clockwise by an angle of 90° so that the right outer opening portion 211 opens only the right section of the upper, lower, left, and right sections of the air discharge port 102, and the inner door 220 is rotated counterclockwise by an angle of 90° so that the lower inner opening portion 221 opens only the lower section of the upper, lower, left, and right sections of the air discharge port 102. Consequently, the sections, which are opened simultaneously by the lower inner opening portion 221 and the right outer opening portion 211, from among the sections of the air discharge port 102, are opened such that air may be discharged to only the above sections.

That is, only the right and lower sections of the upper, lower, left, and right sections of the air discharge port 102 are opened, and most of air discharged from the air conditioning system 100 through the lower right discharge duct 322 and the first lower center discharge duct 327 connected to the right and lower sections such that air may flow therethrough is discharged to the right and lower regions in the vehicle interior space through the lower right vent nozzle 314.

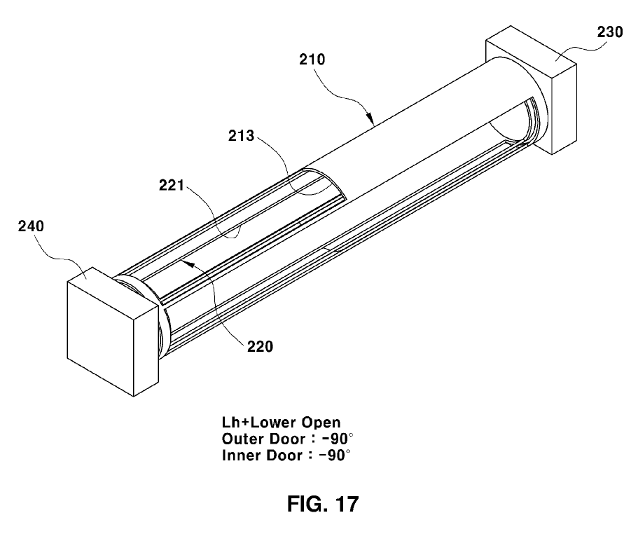

Finally, referring to FIG. 17, when the full open mode of the opening and closing door 200 is converted into a left lower open mode so that the opening and closing door 200 is operated in the left lower open mode, the outer door 210 is rotated counterclockwise by an angle of 90° so that the left outer opening portion 213 opens only the left section of the upper, lower, left, and right sections of the air discharge port 102, and the inner door 220 is rotated counterclockwise by an angle of 90° so that the lower inner opening portion 221 opens only the lower section of the upper, lower, left, and right sections of the air discharge port 102. Consequently, the sections, which are opened simultaneously by the lower inner opening portion 221 and the left outer opening portion 213, from among the sections of the air discharge port 102, are opened such that air may be discharged to only the above sections.

That is, only the left and lower sections of the upper, lower, left, and right sections of the air discharge port 102 are opened, and most of air discharged from the air conditioning system 100 through the lower left discharge duct 324 and the second lower center discharge duct 328 connected to the left and lower sections such that air may flow therethrough is discharged to the left and lower regions in the vehicle interior space through the lower left vent nozzle 316.

In addition, the air in air conditioning system 100, which is introduced into the opening and closing door 200 through the remaining outer and inner opening portions except the outer and inner opening portions located on the air discharge port 102 to open the air discharge port 102, is discharged to the selected discharge ducts through the air discharge port 102.

As such, by combining and controlling the directions and angles of rotation of the outer and inner doors 210 and 220 in various manners, the opening and closing door 200 may be driven in a desired operation mode.

The opening degree of the air discharge port 102 having a substantially rectangular shape may be adjusted according to the operation modes of the opening and closing door 200. Therefore, among the partitioned upper, lower, left, and right sections of the air discharge port 102, the overall air discharge port 102 is fully opened, only the right section of the air discharge port 102 is opened, only the left section of the air discharge port 102 is opened, only the upper section of the air discharge port 102 is opened, only the lower section of the air discharge port 102 is opened, only the right and upper sections of the air discharge port 102 are opened, only the left and upper sections of the air discharge port 102 are opened, only the right and lower sections of the air discharge port 102 are opened, or only the left and lower section of the air discharge port 102 are opened.

In this case, the directions and angles of rotation of the outer and inner actuators 230 and 240, which rotate the outer and inner doors 210 and 220, are adjusted by a controller (not shown) mounted in the vehicle.

That is, the directions and angles of rotation of the outer and inner doors 210 and 220 are adjusted by the controller in the vehicle for controlling the driving of the outer and inner actuators 230 and 240.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for controlling a direction of discharged air in a vehicle air conditioning system, comprising:
a plurality of vent nozzles connected to an air discharge port for discharging air in the vehicle air conditioning system, so as to discharge air to different regions in a vehicle interior space;
a plurality of discharge ducts connected between respective different sections of the air discharge port and the respective vent nozzles; and
an opening and closing door configured to adjust an opening degree of the air discharge port, for selectively opening the different sections of the air discharge port.

2. The apparatus of claim 1, wherein the vent nozzles comprise upper and lower center vent nozzles arranged at a center portion of an instrument panel, formed between the vehicle air conditioning system and the vehicle interior space, while being vertically spaced apart from each other; upper and lower right vent nozzles arranged at a right portion of the instrument panel while being vertically spaced apart from each other; and upper and lower left vent nozzles arranged at a left portion of the instrument panel while being vertically spaced apart from each other.

3. The apparatus of claim 1, wherein the discharge ducts comprise an upper right discharge duct connected between the air discharge port and a right end of the upper right vent nozzle; a lower right discharge duct connected between the air discharge port and a right end of the lower right vent nozzle; an upper left discharge duct connected between the air discharge port and a left end of the upper left vent nozzle; and a lower left discharge duct connected between the air discharge port and a left end of the lower left vent nozzle.

4. The apparatus of claim 3, wherein the discharge ducts comprise a first upper center discharge duct connected between the air discharge port, a right end of the upper center vent nozzle, and a left end of the upper right vent nozzle; a second upper center discharge duct connected between the air discharge port, a left end of the upper center vent nozzle, and a right end of the upper left vent nozzle; a first lower center discharge duct connected between the air discharge port, a right end of the lower center vent nozzle, and a left end of the lower right vent nozzle; and a second lower center discharge duct connected between the air discharge port, a left end of the lower center vent nozzle, and a right end of the lower left vent nozzle.

5. The apparatus of claim 1, wherein the opening and closing door comprises an outer door rotatably installed in the vehicle air conditioning system, and an inner door rotatably installed on the same axis as the outer door; and the outer door has a plurality of outer opening portions circumferentially formed on an outer peripheral surface thereof, and the inner door has a plurality of inner opening portions circumferentially formed on an outer peripheral surface thereof, so that the opening degree of the air discharge port is determined by one of the outer opening portions and one of the inner opening portions depending on directions and angles of rotation of the outer and inner doors.

6. The apparatus of claim 5, wherein the outer opening portions comprise a right outer opening portion, a first full outer opening portion, a left outer opening portion, and a second full outer opening portion sequentially formed in the circumferential direction of the outer door; the right outer opening portion is formed at one of left and right sides with respect to an axial direction of the outer door; the left outer opening portion is formed at the other of the left and right sides with respect to the axial direction of the outer door; and the first and second full outer opening portions are formed at both of the left and right sides so as to extend in the axial direction of the outer door.

7. The apparatus of claim 6, wherein the first and second full outer opening portions face each other on a circumference of the outer door, and the right and left outer opening portions face each other in a diagonal direction on the circumference of the outer door.

8. The apparatus of claim 6, wherein the first and second full outer opening portions are formed so as to open the overall air discharge port, the right outer opening portion is formed so as to open a right section of the air discharge port, and the left outer opening portion is formed so as to open a left section of the air discharge port.

9. The apparatus of claim 5, wherein the inner opening portions comprise a lower inner opening portion, a first full inner opening portion, an upper inner opening portion, and a second full inner opening portion sequentially formed in the circumferential direction of the inner door; the lower inner opening portion is formed at one of upper and lower sides with respect to the circumferential direction of the inner door; the upper inner opening portion is formed at the other of the upper and lower sides with respect to the circumferential direction of the inner door; and the first and second full inner opening portions are formed at both left and right sides so as to extend in an axial direction of the inner door.

10. The apparatus of claim 9, wherein the first and second full inner opening portions face each other on a circumference of the inner door, and the upper and lower inner opening portions are disposed so as to be closer to the first full inner opening portion than to the second full inner opening portion.

11. The apparatus of claim 9, wherein the first and second full inner opening portions are formed so as to open the overall air discharge port, the lower inner opening portion is formed so as to open a lower section of the air discharge port, and the upper inner opening portion is formed so as to open an upper section of the air discharge port.

12. The apparatus of claim 1, wherein each of the vent nozzles has a hollow pipe shape, and is provided with a discharge gap, formed in such a manner that one side of an outer peripheral surface of the vent nozzle is longitudinally opened, for discharging air.

13. The apparatus of claim 5, wherein an outer actuator for rotating the outer door and an inner actuator for rotating the inner door are installed outside the vehicle air conditioning system, and the outer and inner actuators are disposed on axial lines of the outer and inner doors so as to face each other.
